(19) United States
(12) Patent Application Publication
(10) Pub. No.: US 2009/0266838 A1
(43) Pub. Date: Oct. 29, 2009

(54) VENDOR FOR AIR INFLATION MERCHANDISE

(76) Inventor: Shen-Hao Yao, Kaoshiung (TW)

Correspondence Address: Shen-Hao Yao, 235 Chung - Ho, Box 8-24, Taipei, TW

(21) Appl. No.: 12/109,341

(22) Filed: Apr. 25, 2008

(51) Int. Cl. G07F 11/72; G07F 11/00; G07F 11/44; G07F 17/06

(52) U.S. Cl. 221/199; 221/96

(57) ABSTRACT

A vendor for air inflation merchandises comprising a machine body, a merchandise receiving chamber, a merchandise output device and an air inflation device, the machine body providing a space for integrating the merchandise receiving chamber, the merchandise output device and the air inflation device. The merchandise receiving chamber serves for receiving air inflation merchandises which are packaged in boxes. The merchandise output device is installed below the merchandise receiving chamber. When coins are inputted, the air inflation merchandise in the merchandise receiving chamber will output to the merchandise outlet through a guide tube with the driving operation of the merchandise output device so as to achieve the object of selling the merchandise. The air inflation device is further installed with an extendable air transfer tube. One end of the air transfer tube protrudes out of the machine body to be pivoted to an air valve for air inflation by users.

### FIELD OF THE INVENTION

The present invention relates to vendors for air inflation merchandises which is specifically for air inflation balloons, air inflation toys, and other air inflation merchandises.

### BACKGROUND OF THE INVENTION

Since the air inflation balloons, air inflation toys, etc. which are safe, vivid, lovely, light-weighted, have lower costs. Thus, these merchandises are widely accepted by children and are widely used in various different fields. However these air inflation merchandises are used after inflation so that the sellers must inflate these merchandises for selling. Other than more labors and time being needed, greater exhibiting spaces are necessary. These all increases the costs.

### SUMMARY OF THE INVENTION

Accordingly, the object of the present invention is to provide a vendor for air inflation merchandises, which can improve the defect of the current air inflation merchandises. By the vendor of the present invention, the seller can sell the air inflation merchandise easily and conveniently.

To achieve above object, the present invention provides a vendor for air inflation merchandises comprising a machine body, a merchandise receiving chamber, a merchandise output device and an air inflation device; wherein the machine body providing a space for integrating the merchandise receiving chamber, the merchandise output device and the air inflation device; the machine body installed with at least one coin inlet and/or outlet, at least one money inlet and/or outlet and at least one merchandise outlet; the merchandise receiving chamber serves for receiving air inflation merchandises which are packaged in boxes; the merchandise output device is installed below the merchandise receiving chamber; when coins are inputted, the air inflation merchandise in the merchandise receiving chamber will output to the merchandise outlet through a guide tube with the driving operation of the merchandise output device so as to achieve the object of selling the merchandise; and the air inflation device is further installed with an extendable air transfer tube; one end of the air transfer tube protrudes out of the machine body to be pivoted to an air valve for air inflation by users.

The air inflation device is driven electromotively or manually. The air inflation device may be driven by treading upon a pedal which protrudes out of the machine body; and a user can tread the pedal for outputting air.

The various objects and advantages of the present invention will be more readily understood from the following detailed description when read in conjunction with the appended drawing.

### BRIEF DESCRIPTION OF THE DRAWINGS

FIG. 1 is an assembled perspective view of the present invention.

FIG. 2 is a front structural view of the present invention.

FIG. 3 is a right side view of the present invention.

FIG. 4 is a left side view of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

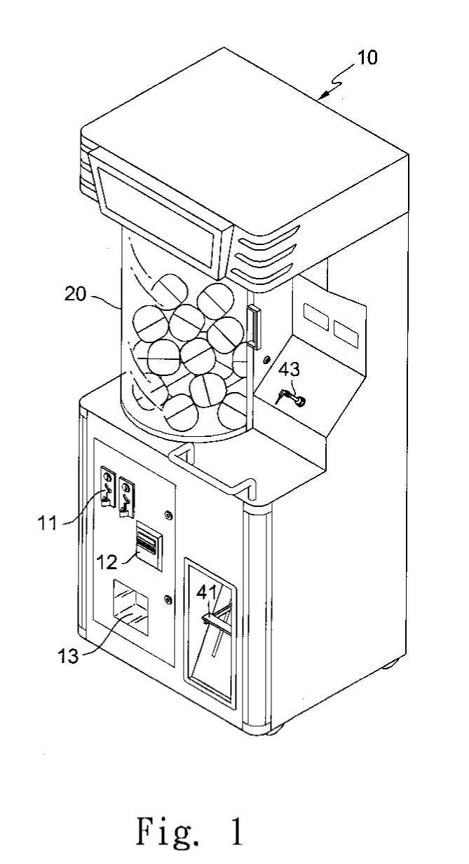

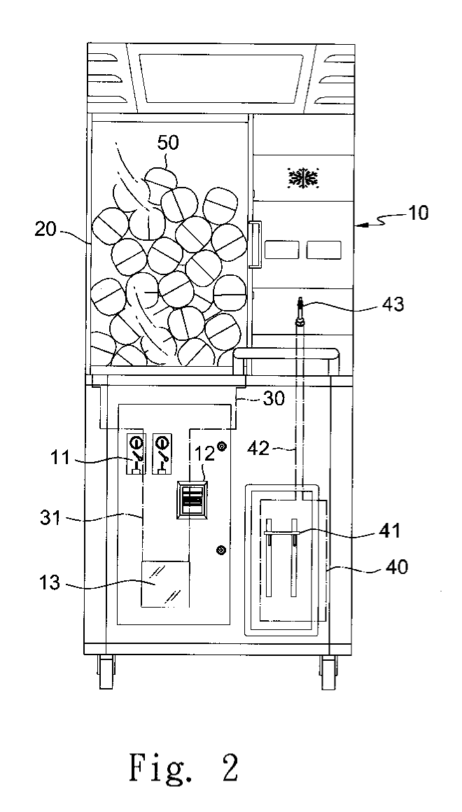

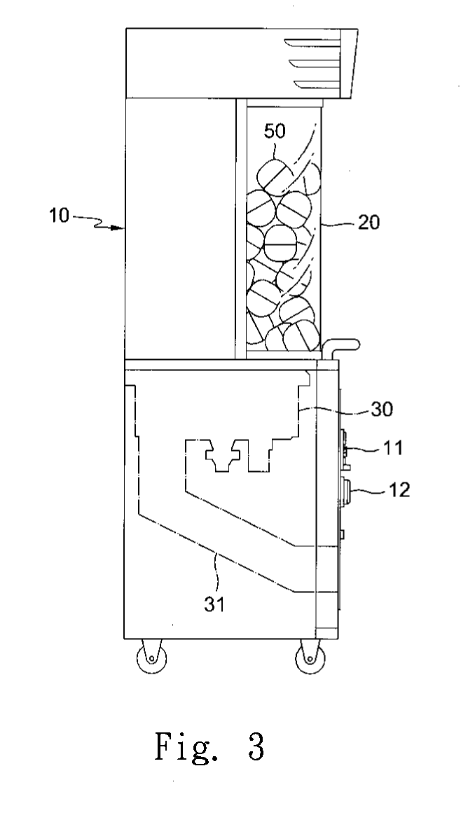

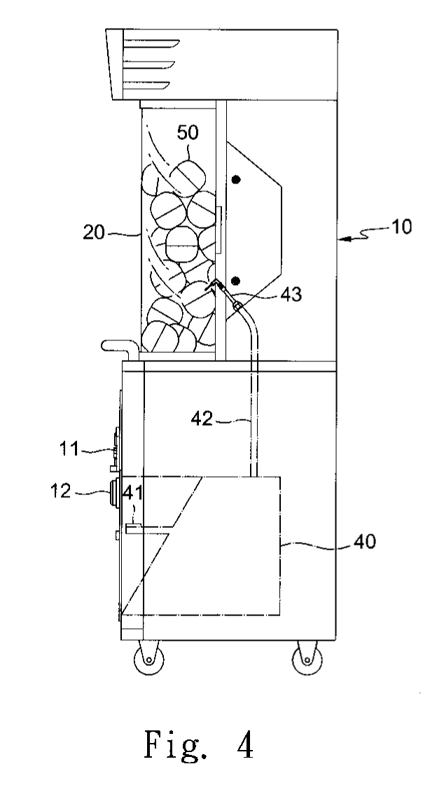

Referring to FIGS. 1 to 4, the structure and technology for realizing the present invention is illustrated.

As illustrated in FIG. 1, the vendor for air inflation merchandises according to the present invention is illustrated. The present invention includes a machine body 10, a merchandise receiving chamber 20, a merchandise output device 30 and an air inflation device 40.

Referring to FIGS. 1 to 4, the machine body 10 provides a space for integrating the merchandise receiving chamber 20, the merchandise output device 30 and the air inflation device 40. The machine body 10 is installed with at least one coin inlet and/or outlet 11, at least one money inlet and/or outlet 12 and at least one merchandise outlet 13.

The merchandise receiving chamber 20 (see FIGS. 1 to 3) serves for receiving air inflation merchandises 50 which are packaged in boxes.

The merchandise output device 30 (as shown in FIG. 1 to 3) is installed below the merchandise receiving chamber 20. When coins are inputted, the air inflation merchandise 50 in the merchandise receiving chamber 20 will output to the merchandise outlet 13 through a guide tube 31 with the driving operation of the merchandise output device 30 so as to achieve the object of selling the merchandise.

Referring to FIGS. 1, 2 and 4, the air inflation device 40 is driven electromotively or manually. The air inflation device 40 is driven by treading upon a pedal 41 which protrudes out the machine body 10. The user can tread the pedal 41 for outputting air. The air inflation device 40 is further installed with an extendable air transfer tube 42. One end of the air transfer tube 42 protrudes out of the machine body 10 to be pivoted to an air valve 43 for air inflation by users.

By above-mentioned structure, the air inflation merchandise 50 can be packed in a box for selling by the vendor. After the buyer gets the air inflation merchandise 50, it can be inflated by the air inflation device 40 of the machine body 10 so as to provide a convenient operation to users.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A vendor for air inflation merchandises comprising a machine body, a merchandise receiving chamber, a merchandise output device and an air inflation device; wherein
the machine body providing a space for integrating the merchandise receiving chamber, the merchandise output device and the air inflation device; the machine body installed with at least one coin inlet and/or outlet, at least one money inlet and/or outlet and at least one merchandise outlet;
the merchandise receiving chamber serves for receiving air inflation merchandises which are packaged in boxes;
the merchandise output device is installed below the merchandise receiving chamber; when coins are inputted, the air inflation merchandise in the merchandise receiving chamber will output to the merchandise outlet through a guide tube with the driving operation of the merchandise output device so as to achieve the object of selling the merchandise; and
the air inflation device is further installed with an extendable air transfer tube; one end of the air transfer tube protrudes out of the machine body to be pivoted to an air valve for air inflation by users.

2. The vendor for air inflation merchandises as claimed in claim 1, wherein the air inflation device is driven electrically or manually.

3. The vendor for air inflation merchandises as claimed in claim 1, wherein the air inflation device is driven by treading upon a pedal which protrudes out of the machine body; and a user can tread the pedal for output air.
